(19) United States
(12) Patent Application Publication
(10) Pub. No.: US 2008/0280273 A1
(43) Pub. Date: Nov. 13, 2008

(54) Multipurpose Abacus

(76) Inventor: Han-Cheun Lee, Paju-Shi (KR)

Correspondence Address: IPLA P.A., 3580 WILSHIRE BLVD., 17TH FLOOR, LOS ANGELES, CA, 90010, US

(21) Appl. No.: 12/090,240

(22) PCT Filed: May 24, 2006
(86) PCT No.: PCT/KR2006/001940

§ 371 Date: Apr. 14, 2008

(30) Foreign Application Priority Data
Oct. 13, 2005 (KR) 10-2005-0096443
Apr. 7, 2006 (KR) 10-2006-0031846
May 24, 2006 (KR) PCT/KR2006/001940

(51) Int. Cl. G06C 1/00

(52) U.S. Cl. 434/203

(57) ABSTRACT

A multipurpose abacus is disclosed. The multipurpose abacus of the present invention includes an abacus frame, which is closed at the bottom thereof and has upper, lower, left and right frame walls (10), (30), (20), (40). Support rod insertion holes (11) and (31) are respectively formed in the upper and lower frame walls. Partition bar insertion parts (21) and (41) are respectively provided on the right and left frame walls. Supports (51) are provided on the bottom plate (50) at positions corresponding to the partition bar insertion parts. The multipurpose abacus further includes a plurality of support rods (80), which are inserted into the support rod insertion holes of the upper and lower frame walls, a plurality of beads (90), which are fitted over each support rod, and at least one partition bar (60), which is removably inserted into the partition bar insertion parts of the left and right frame walls.

### TECHNICAL FIELD

multipurpose abacus, in which a plurality of beads is provided on rods installed in a rectangular frame, and the beads are separated into upper and lower sides by at least one removable partition bar.

### BACKGROUND ART

With the advance of industrial society, abacuses have become seldom used and are treated as antique articles. Some time ago, abacuses were very frequently used in daily life, but, recently, it is difficult even to see abacuses in one's surroundings. Such an abacus was invented before Christ, was a daily tool and a mathematical tool, and has developed along with human society.

Typically, the abacus has been regarded merely as a tool for calculation. Although the abacus does not really have other functions other than the calculation function, abacus calculation has played and important part in understanding the notion of numbers and calculation and in enhancing calculating ability.

### DISCLOSURE OF INVENTION

### Technical Problem

Accordingly, the necessity of using the abacus as a new learning tool having a function as an educational aid for helping elementary schoolchildren improve their comprehension of numbers and calculation and their calculating ability has been required.

Meanwhile, in the case of using a conventional assistant abacus, which improves on a typical abacus, it has been difficult for students to learn general arithmetic, for example, the comprehension of the structure and characteristics of numbers, comparison of numbers, comprehension of the notion of arithmetic sign, and the solution or composition of numbers. That is, the abacus has been merely used for uniform calculation, for example, simple addition, a process of subtracting a complement number, or a process of subtracting ten and shifting a complement number. Therefore, an assistant abacus for learning the mathematic notion and principle, which are important in the learning process of students, is required.

However, the assistant abacus is problematic in that it is used independently of the abacus for learning (for teaching). Furthermore, in consideration of the characteristics of mathematics which, if the notion and principle of the number are not understood, applied problems and problems requiring thinking ability cannot be solved, a multipurpose abacus, which makes it possible to conduct various learning processes using a single tool, is required.

### Technical Solution

Accordingly, the present invention has been made keeping in mind the above problems occurring in the prior art, and an object of the present invention is to provide a multipurpose abacus, in which a removable partition bar, which separates beads, and an abacus frame are assembled into a single body, and which is closed at one side of the abacus frame, thus providing a sensation of stability to a user during a learning process.

Another object of the present invention is to provide a multipurpose abacus, which is a detachable structure, and which allows anybody to easily conduct various learning work, such as counting numbers (number to 9, 50 or 100 or three figures), separation and collection of beads, addition and subtraction, multiplication, division and a stacking game.

Advantageous Effects imparts a sensation of stability to a user. Furthermore, protrusions for supporting a partition bar are provided on a bottom plate of the frame, so that the partition bar is prevented from undesirably moving.

As well, according to another embodiment of the present invention, the multipurpose abacus of the above-mentioned embodiment may have a detachable structure.

### BRIEF DESCRIPTION OF THE DRAWINGS

FIG. 3 is a perspective view showing the embodiment of FIG. 1 according to the present invention;

FIG. 4 is a perspective view of a multipurpose abacus, according to another embodiment of the present invention;

FIGS. 5a through 5c are perspective views showing parts of an abacus frame of the abacus of FIG. 4 and the assembled abacus frame;

FIGS. 6a and 6b are exploded perspective views of a support rod of FIG. 4; and

FIGS. 7a and 7b are exploded perspective views of a partition bar of FIG. 4.

### DESCRIPTION OF THE ELEMENTS IN THE DRAWINGS

10, 100: upper frame wall
11, 31, 110: support rod insertion hole
12: coupling protrusion
20, 400: right frame wall
21, 41, 310: partition bar insertion part
22: coupling hole
30, 200: lower frame wall
40, 300: left frame wall
50: bottom plate
51: support
60, 70, 600, 700: partition bar
61, 71: insertion slot
80, 800: support rod
90, 900: beads
120: coupling protrusion
320: coupling hole
610, 620: partition bar body
630, 640: notch
650: support rod passing hole
810: insertion protrusion
820: insertion hole

### BEST MODE FOR CARRYING OUT THE INVENTION

Accomplish the above objects, the present invention provides a multipurpose abacus, including: an abacus frame closed at a bottom thereof and provided with upper, lower, left and right frame walls having predetermined heights, with support rod insertion holes formed in the upper and lower frame walls at positions corresponding to each other, partition bar insertion parts provided on the left and right frame walls, and a plurality of supports provided on the bottom of the abacus frame at positions corresponding to the partition bar insertion parts to prevent a partition bar from undesirably moving; a plurality of support rods inserted into the upper and lower support rod insertion holes; a plurality of beads fitted over each support rod; and at least one partition bar removably inserted into the partition bar insertion parts of the left and right frame walls accomplish the above objects, the present invention provides a multipurpose abacus, including: an abacus frame formed by upper, lower, left and right frame walls having predetermined heights, the abacus frame being open at upper and lower sides thereof, with support rod insertion holes formed in the upper and lower frame walls at positions corresponding to each other, and partition bar insertion parts provided on the left and right frame walls; a plurality of support rods inserted into the upper and lower support rod insertion holes; a plurality of beads fitted over each support rod; and at least one partition bar removably inserted into the partition bar insertion parts of the left and right frame walls, the partition bar being divided into two partition bar bodies, so that, when the two partition bar bodies are assembled with each other, holes, through which the support rods pass, are formed.

### MODE FOR THE INVENTION

Hereinafter, the construction and operation of embodiments of the present invention will be described in detail with reference to the attached drawings.

The multipurpose abacus further includes a plurality of beads 90, which is fitted over each support rod 80.

The multipurpose abacus further includes a plurality of partition bars 60 and 70, each of which has a plurality of insertion slots 61, 71 at positions corresponding to the support rods 80 so that each support rod 80 is inserted into the insertion slots 61 and 71, and which are inserted at opposite ends thereof into the partition bar insertion parts 21 and 41 of the left and right frame walls 40 and 20 so that the beads 90 are separated into the upper and lower sides by the partition bars 60 and 70.

Preferably, in a state in which one of the upper and lower frame walls 10 and 30 is removed from the abacus frame, the support rods 80, over which the beads 90 are fitted, are inserted into the support rod insertion holes 31. Thereafter, the upper or lower frame wall 10 or 30 is coupled and bonded to the left and right frame walls 40 and 20 and the upper end of the bottom plate 50, thus completing the embodiment of the present invention.

Referring to FIG. 1, coupling protrusions 12 may be provided under respective opposite ends of the lower surface of the upper frame wall 10, and a coupling hole 22 may be formed in an upper end of each of the left and right frame walls 40 and 20, so that the coupling protrusions 12 of the upper frame wall 10 are fitted into the coupling holes 22 of the left and right frame walls, thus forming the abacus frame.

Furthermore, each partition bar insertion part 21 of the right frame wall 20 and each corresponding partition bar insertion part 41 of the left frame walls 40 is disposed at the same height relative to the lower frame wall 30.

Each partition bar insertion part 21, 41, which is provided on each of the right and left frame walls 20 and 40, may comprise a groove or protrusion, which can support each end of the partition bar 60, 70.

Furthermore, each support 51, which is provided on the bottom plate 50, may comprise a groove, which is formed in the bottom plate 50 such that, when the partition bar 60, 70 is coupled to the bottom plate 50, an edge of the partition bar 60, 70 is inserted into and supported by the groove of the bottom plate 50.

In the embodiment of FIG. 1, although the partition bars 60 and 70 have been described as being inserted into the partition bar insertion part 21 and 41 of the right and left frame walls 20 and 40, as required, the present invention may be constructed such that the partition bars 60 and 70 have various lengths shorter than the partition bar 60, 70 of the embodiment of FIG. 1, and each partition bar 60, 70 is inserted into only one partition bar insertion part 21, 41 of the right frame wall 20 or the left frame wall 20. In this case, the number of support rods 80 corresponding to the length of the partition bar 60, 70 are provided to separate the beads 90 into the upper and lower sides.

Furthermore, each support 51, which is provided on the bottom plate 50, is disposed at a position corresponding to the related partition bar insertion parts 21 and 41, which are provided on the right and left frame walls 20 and 40.

As well, the upper frame wall 10 or the lower frame wall 30 of the abacus frame may be removably provided.

FIG. 2 is a view illustrating use of the present invention. After the assembly of the abacus frame, the support rods and the beads has been completed, according to the intended purpose of a user, the abacus of the present invention may be used without the partition bars 60 and 70. In this case, all of the beads are used for educational purposes. Alternatively, only a single partition bar 60 may be used. In this case, the partition bar 60 is inserted into the partition bar insertion parts 21 and 41, which are disposed at desired positions depending on the base number of the beads. Then, the support rods 80 are inserted into the respective insertion slots 61 of the partition bar 60, and, when the partition bar 60 comes into contact with the bottom plate 50, the supports 51, which are provided on the bottom plate 50, support the upper and lower surfaces of the partition bar 60, which contacts the bottom plate 50, thus securely holding the partition bar 60 such that the partition bar 60 is prevented from undesirably moving.

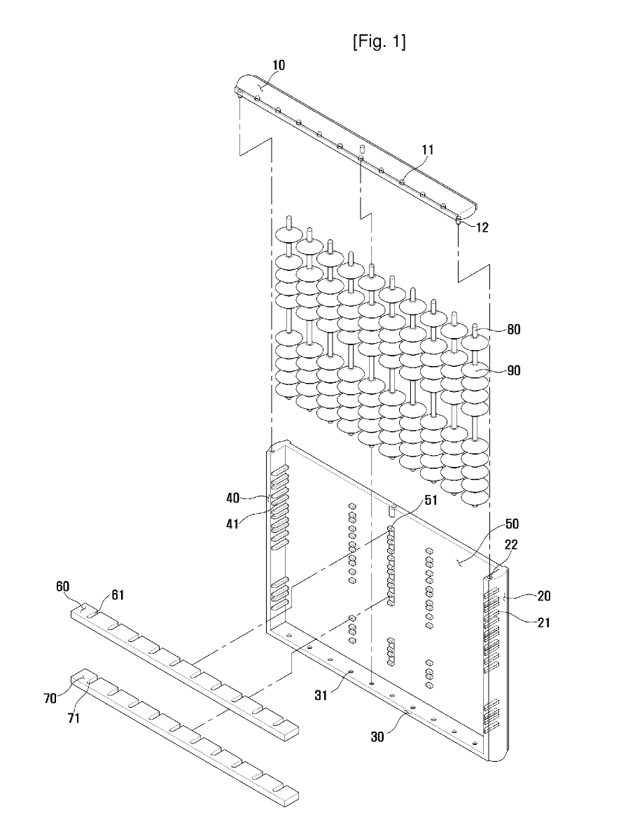

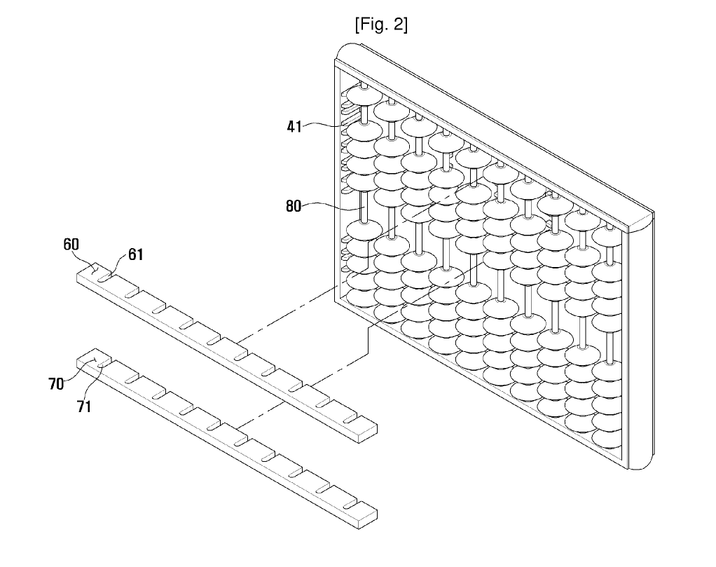

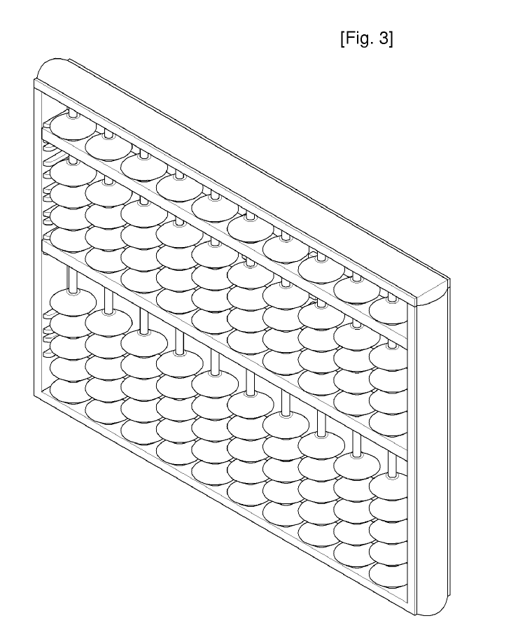

FIG. 3 is a view illustrating use of the abacus, in which the beads are separated by the two partition bars 60 and 70.

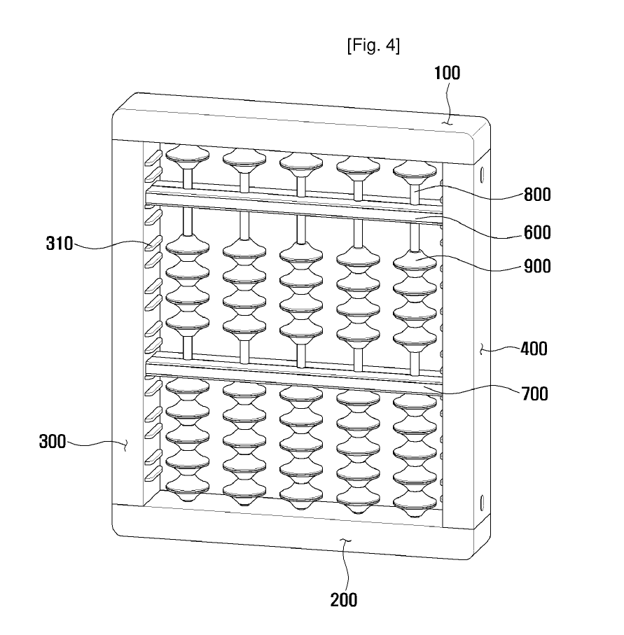

FIG. 4 is a perspective view of a multipurpose abacus, according to another embodiment of the present invention.

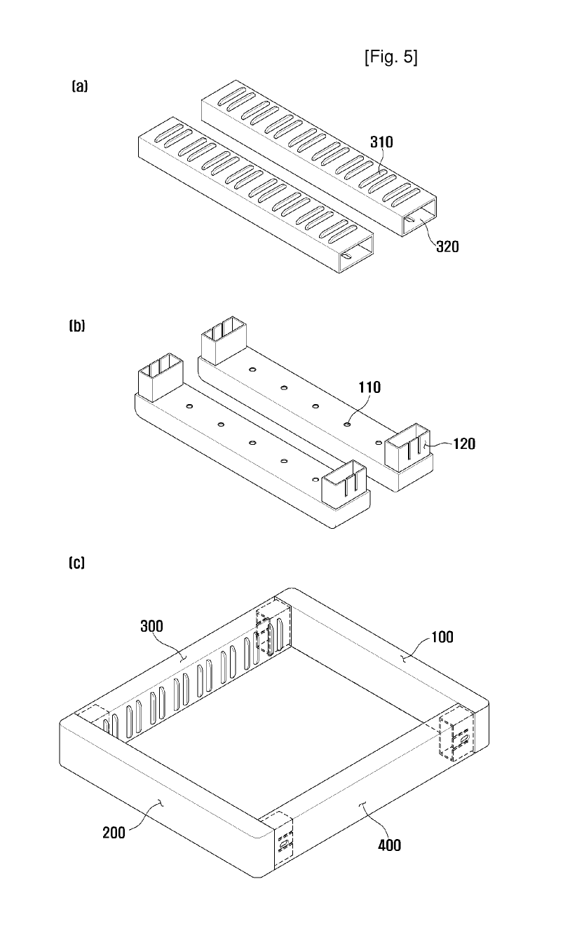

FIGS. 5a through 5c are perspective views showing parts of the abacus frame of FIG. 4 and the assembled abacus frame.

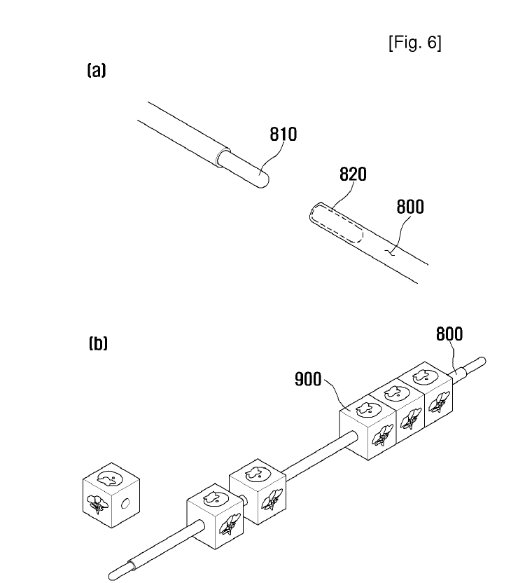

FIGS. 6a and 6b are exploded perspective views of the support rod of FIG. 4.

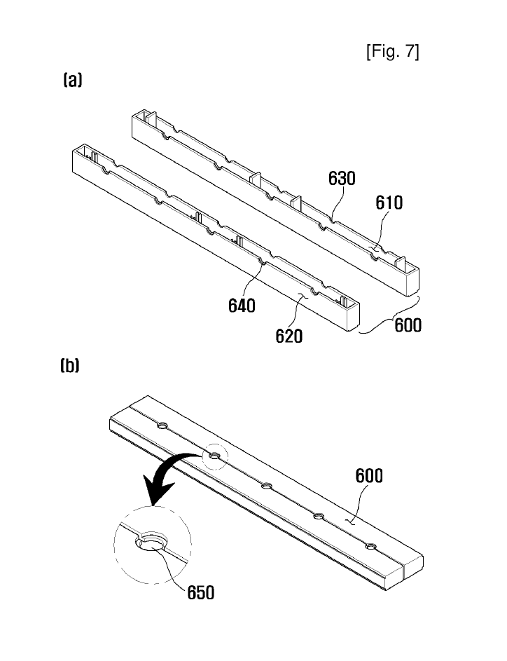

FIGS. 7a and 7b are exploded perspective views of the partition bar of FIG. 4.

As shown in FIG. 4, the multipurpose abacus according to this embodiment of the present invention includes a rectangular abacus frame (100, 200, 300 and 400), a plurality of rods 800, which are installed in the abacus frame (100, 200, 300 and 400) in a vertical direction, partition bars 600 and 700, which are fitted over the rods 800 and are installed in the abacus frame (100, 200, 300 and 400) in a sideways direction using partition bar insertion parts 310, which are provided on the inner surfaces of left and right frame walls 300 and 400, and a plurality of beads 900, which are fitted over each rod 800. Here, the multipurpose abacus of the present invention may be made of synthetic resin, such as plastic, wood, or metal such as aluminum. Furthermore, the multipurpose abacus may have various colors.

The detailed description of the elements of the multipurpose abacus is presented below.

As shown in FIGS. 5a through 5c, in the rectangular abacus frame (100, 200, 300 and 400), circular rod insertion holes 110 are formed in upper and lower frame walls 100 and 200 at positions corresponding to each other. Furthermore, a coupling protrusion 120 having a predetermined length is perpendicularly provided on each of opposite ends of the upper and lower frame walls 100 and 200 or each of opposite ends of the left and right frame walls 300 and 400. As well, a coupling hole 320 is formed in each of opposite ends of the upper and lower frame walls 100 and 200 or each of opposite ends of the left and right frame walls 300 and 400, so that the coupling protrusions 120 are inserted into the respective coupling holes 320.

As shown in FIG. 6a, a circular insertion protrusion 810 is provided on an end of each rod 800. A plurality of rod insertion holes 110 is formed in each of the upper and lower frame walls 100 and 200 of the abacus frame, so that the circular insertion protrusions 810 of the rods 800 are fitted into the respective rod insertion holes 110. Furthermore, an insertion hole 820 is formed in the other end of each rod 800, so that, when it is required to extend the length of the rod 800, the insertion protrusion 810 of one rod 800 may be coupled to the insertion hole 110 of another rod 800. For example, ten beads are basically fitted over each rod 800, and, when a number of beads greater than ten is required, a desired number of rods 800 may be coupled to each other.

Furthermore, the beads 900 are fitted over each rod 800. Here, the beads 900 may comprise picture blocks, which are fitted over each rod 800, as shown in FIG. 6b. In this case, each picture block may have a magnet therein.

The partition bar 600 is supported by the partition bar insertion parts 310 provided on the opposite surfaces of the left and right frame walls 300 and 400 of the abacus frame, thus being installed in the abacus frame in a sideways direction. As shown in FIG. 7a, the partition bar 600 is separated into two bodies 610 and 620. Notches 630 and 640 are respectively formed in the two partition bar bodies 610 and 620 at positions corresponding to the rod insertion holes 110 of the upper and lower frame walls 100 and 200. Thus, as shown in FIG. 7b, when the two bodies 610 and 620 of the partition bar 600 are assembled with each other such that the notches 630 and 640 face each other, rod passing holes 650 are formed.

The process of assembling the abacus of this embodiment of the present invention will be explained herein below.

The beads 900 are first fitted over each rod 800. Thereafter, the rods 800 are inserted into the rod insertion holes 110 of the upper frame wall 100 and, subsequently, the coupling protrusions 120, which are provided on the opposite ends of the upper frame wall 100, are inserted into the respective coupling holes 320, which are formed in the upper ends of the left and right frame walls 300 and 400. The lower ends of the rods 800 are thereafter inserted into the respective rod insertion holes 110 of the lower frame wall 200 and, simultaneously, the coupling protrusions 120, which are provided on the opposite ends of the lower frame wall 200, are inserted into the respective coupling holes 320, which are formed in the lower ends of the left and right frame walls 300 and 400, thus obtaining the rectangular abacus frame having the beads 900. Thereafter, the two bodies 610 and 620 of the partition bar 600 are inserted into the partition bar insertion parts 310 at opposite sides of the rods 800 and are thus coupled to each other, such that the rods 800 are seated in the related rod passing holes 650 of the assembled partition bar 600, thus completing the assembly of the abacus of the embodiment of the present invention.

The beads 900 may be manufactured in various shapes, for example, picture blocks. Here, when a learning process is conducted using the picture blocks or beads, separate casings for containing the picture blocks or beads, which are relatively short and small, may be used.

The casings may be manufactured in various sizes, for example, to a length of 1 cm, 1.5 cm, 1.7 cm, etc., without restriction. Preferably, the casings are manufactured to a size corresponding to a multiple of that of the picture blocks or beads. Furthermore, as required, casings having various sizes are provided.

For example, when one picture block or bead exists, it is contained in the casing having a size corresponding to the size of one picture block or bead. When two picture blocks or beads exist, they are contained in the casing having a size corresponding to the size of two picture blocks or beads.

### INDUSTRIAL APPLICABILITY

The present invention relates, in general, to multipurpose abacuses and, more particularly, to a multipurpose abacus in which a plurality of beads is provided on rods installed in a rectangular frame, and the beads are separated into upper and lower sides by at least one removable partition bar. The multipurpose abacus of the present invention can be regarded as a technique having high applicability.

1. A multipurpose abacus, comprising:
an abacus frame, comprising: a rectangular bottom plate having a predetermined size, with a plurality of supports provided on the bottom plate: a left frame wall and a right frame wall extending predetermined heights from respective opposite side edges of the bottom plate, with a plurality of partition bar insertion parts provided on an inner surface of each of the right and left frame walls; and an upper frame wall and a lower frame wall extending predetermined heights from upper and lower edges of the bottom plate, respectively, with a plurality of support rod insertion holes formed in an inner surface of each of the upper and lower frame walls;
a plurality of beads fitted over each support rod; and
at least one partition bar having a plurality of insertion slots at positions corresponding to the support rods so that each support rod is inserted into each insertion slot, the partition bar being inserted at opposite ends thereof into the partition bar insertion parts of the left and right frame walls so that the beads are separated into upper and lower sides by the partition bar.

2. A multipurpose abacus, comprising:
an abacus frame, comprising: upper and lower frame walls having predetermined lengths, with a plurality of support rod insertion holes formed in an inner surface of each of the upper and lower frame walls; and left and right frame walls, with a plurality of partition bar insertion parts provided on an inner surface of each of the left and right frame walls, each of the upper, lower, left and right frame walls having a coupling means. so that the abacus frame is formed by assembling upper. lower, left and right frame walls together into a rectangular shape;
a plurality of support rods inserted into the support rod insertion holes of the upper and lower frame walls of the abacus frame;
a plurality of beads fitted over each support rod; and
a partition bar having two partition bar bodies. each of which has support rod receiving notches at predetermined positions corresponding to the support rods, so that the two partition bar bodies are inserted into the partition bar insertion parts 310 at opposite sides of the support rods and are coupled to each other, such that the support rods are seated into corresponding rod passing holes formed by the support rod receiving notches.

3. The multipurpose abacus according to claim 1, wherein the partition bar insertion parts of the left and right frame walls are provided at positions spaced apart from the lower frame wall to a same height.

4. The multipurpose abacus according to claim 1, wherein each of the partition bar insertion parts protrudes from each of the left and right frame walls to receive an end of each partition bar.

5. The multipurpose abacus according to claim 1, wherein each of the partition bar insertion parts comprises a groove formed in each of the left and right frame walls to receive an end of each partition bar.

6. The multipurpose abacus according to claim 1, wherein each of the supports provided on the bottom plate comprises protrusions which support upper and lower surfaces of the partition bar when the partition bar is placed into the abacus frame and comes into contact with the bottom surface.

7. The multipurpose abacus according to claim 1, wherein each of the supports provided on the bottom plate comprises a groove, into which a side edge of the partition bar is inserted when the partition bar is placed into the abacus frame and comes into contact with the bottom surface.

8. The multipurpose abacus according to claim 1, wherein each of the supports is provided on the bottom plate at a position corresponding to the related support rod insertion parts provided on the left and right frame walls.

9. The multipurpose abacus according to claim 1, wherein the upper or lower frame wall of the abacus frame is removable.

10. The multipurpose abacus according to claim 1, wherein the partition bar has a length shorter than the upper frame wall so that the partition bar is inserted into the support rod insertion part of either the left or right frame wall.

11. The multipurpose abacus according to claim 1, wherein each of the support rods has an insertion protrusion on a first end thereof and has an insertion hole on a second end thereof, so that, as required, the insertion protrusion of one support rod is inserted into the insertion hole of another support rod, thus extending a length of the support rods.

12. The multipurpose abacus according to claim 1, wherein each of the beads fitted over each support rod comprises a typical circular bead or a polyhedral picture block, and the polyhedral picture block has a magnet therein.

13. The multipurpose abacus according to claim 12, further comprising: a casing to contain the picture block or circular beads therein, the casing comprising a plurality of casings having different sizes corresponding to the number of picture blocks or circular beads.

14. The multipurpose abacus according to claim 1, wherein the multipurpose abacus is made of synthetic resin, such as plastic, wood, or metal such as aluminum, and has various colors.

15. The multipurpose abacus according to claim 2, wherein the partition bar insertion parts of the left and right frame walls are provided at positions spaced apart from the lower frame wall to a same height.

16. The multipurpose abacus according to claim 2, wherein each of the partition bar insertion parts protrudes from each of the left and right frame walls to receive an end of each partition bar.

17. The multipurpose abacus according to claim 2, wherein each of the partition bar insertion parts comprises a groove formed in each of the left and right frame walls to receive an end of each partition bar.

18. The multipurpose abacus according to claim 2, wherein each of the support rods has an insertion protrusion on a first end thereof and has an insertion hole on a second end thereof, so that. as required, the insertion protrusion of one support rod is inserted into the insertion hole of another support rod, thus extending a length of the support rods.

19. The multipurpose abacus according to claim 2, wherein each of the beads fitted over each support rod comprises a typical circular bead or a polyhedral picture block, and the polyhedral picture block has a magnet therein.

20. The multipurpose abacus according to claim 2, wherein the multipurpose abacus is made of synthetic resin, such as plastic, wood, or metal such as aluminum, and has various colors.
